(19) United States
(12) Patent Application Publication
(10) Pub. No.: US 2003/0186608 A1
(43) Pub. Date: Oct. 2, 2003

(54) Fabric with pain-relieving characteristics and structures fabricated therefrom, and method

(76) Inventor: Arthur Goldberg, Livingston, NJ (US)

Correspondence Address: SUMMA & ALLAN, P.A., 11610 NORTH COMMUNITY HOUSE ROAD, SUITE 200, CHARLOTTE, NC, 28277, US

(21) Appl. No.: 10/392,036

(22) Filed: Mar. 19, 2003

Related U.S. Application Data
(63) Continuation-in-part of application No. 10/109,177, filed on Mar. 28, 2002.

(51) Int. Cl. D03D 15/00; B32B 9/00; B32B 19/00

(52) U.S. Cl. 442/304; 428/367; 428/357; 442/208

(57) ABSTRACT

A fabric for reducing endogenous pain by application of the fabric to a pain site to facilitate the flow of endogenous electrical current in the body. The fabric is made from an electrically-conductive yarn and an electrically nonconductive yarn. The fabric is designed to be incorporated into textile articles such as bandages, braces, and clothing.

### TECHNICAL FIELD AND BACKGROUND OF THE INVENTION

This invention is a continuation-in-part of co-pending U.S. patent application Ser. No. 10/109,177, filed on Mar. 28, 2002.

This invention relates to a fabric with pain-relieving characteristics, structures such as garments and bandages constructed therefrom, and related methods. It has been observed that by incorporating two different types of electrically-conductive fibers into a fabric, and structuring the fabric in such a way that the two electrically-conductive fibers coil together and touch each other, an electric current can be induced of sufficient magnitude to generate a current flow and an electric field.

It is also known that some forms of pain are accompanied by an increase in resistance to endogenous electrical flow arising from interrupted, damaged, or compressed cells. This is discussed in U.S. Pat. No. 6,014,585, particularly at columns 1 and 2. The '585 patent discloses the use of an ion-conducting tape which is stuck to the body at the pain site. Other patents cited within the '585 patent disclose other various methods of pain reduction. Endogenous electrical flow within the body, that is, electrical flow within the body originating from the organism itself, can therefore be stimulated for purposes of pain relief.

The inventor observed as a result of a pain-inducing household accident while holding a piece of knitted fabric according to a particular construction, that application of the fabric to the pain site can result in immediate, total relief from the pain. No representation is made that any cure occurs, or that any palliative effect results which last after removal of the fabric.

The related application, Ser. No. 10/109,177, discloses a particular construction of fabric that provides pain relief. That construction utilizes a knitted base fabric having a first electrically-conductive carbon fiber knitted into and extending along a first selected wales and transversely along first selected courses of the base fabric. The '177 construction also has a second electrically-conductive carbon fiber knitted into and extending along second selected wales and transversely along second selected courses of the base fabric. The first and second electrically-conductive fibers are arranged to come into contact with one another as they progress through the base fabric.

It has now been observed that alternative fabric constructions provide improved pain relief. In particular, it has been observed that coiling two different types of electrically-conductive fibers then incorporating this coil into a fabric will result in a fabric that will induce the flow of electrical current across skin when the fabric is placed either in contact with the skin or close enough for the electrical field of the body to contact the electrical field of the fabric.

### SUMMARY OF THE INVENTION

Therefore, it is an object of the invention to provide a fabric which relieves pain when applied to and maintained on a body part that is the source of pain or is experiencing pain.

It is another object of the invention to provide a method for reducing endogenous pain by stimulating a flow of endogenous electrical current in the body.

It is another object of the invention to provide a fabric which can be constructed into structures which can be applied to and maintained on a pain site to relieve pain.

It is another object of the invention to provide a method of constructing a fabric which can be used to construct garments and medical products which can be placed and held against a pain site.

These and other objects of the invention are achieved in the preferred embodiments disclosed below by providing a knitted fabric for reducing endogenous pain through application of the fabric to a pain site to facilitate the flow of endogenous electrical current in the body. In one embodiment, the fabric according to the invention comprises a yarn of nonconducting material and a first electrically-conductive carbon fiber coiled with a second electrically-conductive carbon fiber to create electrical contact between the two electrically-conductive carbon fibers. Preferably, the first and second electrically-conductive carbon fibers are coiled by twisting them together to form a single electrically-conductive yarn

Alternatively, the first and second electrically-conductive carbon fibers are coiled by first forming a first conductive yarn consisting essentially of the first electrically-conductive carbon fiber then a second conductive yarn consisting essentially of the second electrically-conductive carbon fiber. The first and second conductive yarns are then coiled by knitting the yarns together or stitching them in a crisscross pattern.

The invention is also embodied by a method of reducing endogenous pain by stimulating a flow of endogenous electrical current in the body. The method according to the invention comprises the steps of knitting a fabric comprising a yarn of nonconducting material and a first electrically-conductive carbon fiber and a second electrically-conductive carbon fiber that are coiled together to ensure electrical contact between the two electrically-conductive carbon fibers. The method further comprises the steps of applying the fabric to a pain site and maintaining the fabric on the pain site for the duration of desired relief.

A further embodiment of the invention comprises a method of forming a knitted fabric for reducing endogenous pain by stimulating a flow of endogenous electrical current in the body. The method for forming the knitted fabric comprises knitting a yarn of nonconducting material together with a first electrically-conductive carbon fiber and a second electrically-conductive carbon fiber. In this method, the first and second electrically-conductive carbon fibers are coiled together to ensure electrical contact between the electrically-conductive carbon fibers.

### BRIEF DESCRIPTION OF THE DRAWINGS

Some of the objects of the invention have been set forth above. Other objects and advantages of the invention will appear when taken in conjunction with the following drawings, in which:

FIG. 1 is a schematic of an electrically conductive yarn according to the invention;

FIG. 2 is a schematic of a fabric construction according to the invention;

FIG. 3 is a schematic of an alternative fabric construction according to the invention;

FIG. 4 is a schematic of a fabric construction according to the invention;

FIG. 5 is a stitch diagram of one embodiment of the fabric according to the invention;

FIG. 6 is a glove constructed of a fabric according to a preferred embodiment of the invention;

FIGS. 7 and 8 show a bandage in the form of a splint which incorporates a fabric covering in accordance with a preferred embodiment of the invention; and

FIG. 9 is a pad incorporating a fabric according to the invention.

### DESCRIPTION OF THE PREFERRED EMBODIMENT AND BEST MODE

Referring now specifically to the drawings, in one preferred embodiment the invention is a fabric 10 for reducing endogenous pain by application of the fabric 10 to a body part to facilitate the flow of endogenous electrical current in the body. Throughout this detailed description the invention will be discussed in the context of application of the invention to a human body and human skin. The application of the invention, however, is not so limited and may encompass the treatment of any animal. Accordingly, the terms “pain site,” “body,” and “skin” should be interpreted to include any animal and not just humans.

Similarly, the detailed description uses terms such as yarn, fiber and filament that are somewhat overlapping. For example, fibers are cut from longer filaments and yarns are typically a collection of fibers or filaments. These terms are well known to those skilled in the textile arts and their intended meaning will be clear from the context in which they are used.

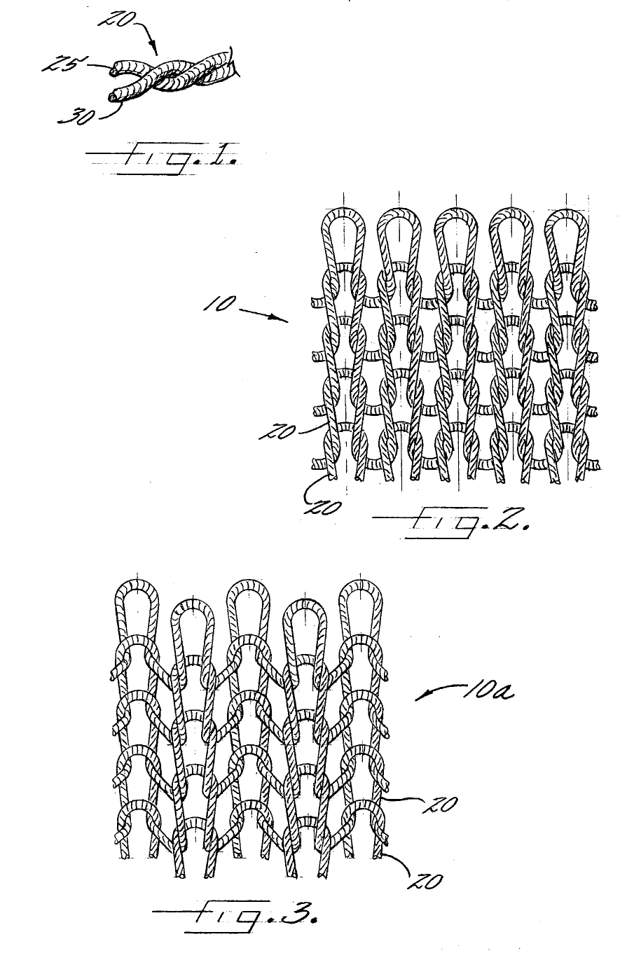

In one embodiment, the fabric according to the invention comprises a yarn of nonconducting material and a first electrically-conductive carbon fiber coiled with a second electrically-conductive carbon fiber to create electrical contact between the two electrically-conductive carbon fibers. As used herein the term coiled means the wrapping or looping of one fiber around the other when the fibers are twisted together or knitted together to thereby create an electric coil. Referring now to FIG. 1, in one preferred embodiment, a first electrically-conductive carbon fiber 25 and a second electrically-conductive carbon fiber 30 are coiled by twisting them together to create a single electrically-conductive yarn 20.

It should be understood that FIG. 1 is illustrative only and that the single electrically-conductive yarn 20 may include multiple first and second electrically-conductive fibers in any ratio. Preferably the ratio of first and second electrically-conductive fibers (25, 30) in the yarn of conductive material 20 is about 50-50. Although the practice of the invention is not limited by the deniers of the yarns discussed herein, preferably the single electrically-conductive yarns 20 utilized in the practice of the invention are between about 1 denier and about 180 deniers.

In preferred embodiments, the first electrically-conductive carbon fiber 25 is chosen from the group consisting of carbon fibers comprising suffused nylon filamentary polymer substrates having finely divided, electrically-conductive particles embossed on the surface of the polymer; carbon fibers comprising a core of electrically-conductive carbon surrounded by an electrically nonconductive polymer cover; and graphite fibers.

The second electrically-conductive carbon fiber 30 is chosen from the group consisting of carbon fibers comprising suffused nylon filamentary polymer substrates having finely divided, electrically-conductive particles embossed on the surface of the polymer; carbon fibers comprising a core of electrically-conductive carbon surrounded by an electrically nonconductive polymer cover; and graphite fibers, but exclusive of the carbon fiber comprising the first electrically-conductive fiber 25.

In more preferred embodiments, the first electrically-conductive carbon fiber 25 is a carbon suffused nylon and the second electrically-conductive carbon fiber 30 comprises a core of electrically-conductive carbon surrounded by an electrically nonconductive polymer cover. Such fibers are commercially available and are sold under the trademarks RESISTAT® and NEGASTAT® respectively.

NEGASTAT® is a carbon fiber comprising a core of electrically-conductive carbon surrounded by an electrically nonconductive polymer cover. NEGASTAT® is a patented product originally produced by DuPont but is now marketed by William Barnette & Sons, LLC. The NEGASTAT® fiber has a trilobal cross-section and the cover may comprise either polyester or nylon.

RESISTAT® is a carbon fiber comprising suffused nylon filamentary substrates having finely divided, electrically-conductive particles embossed on the surface of the nylon. RESISTAT® fibers are commercially available from Shakespeare Conductive Fibers, LLC of Columbia, S.C.

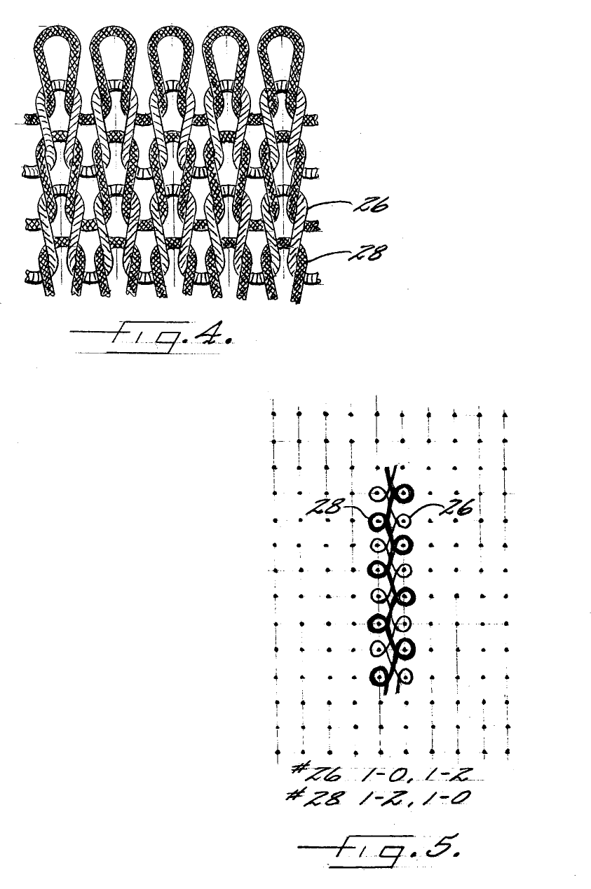

Turning now to FIGS. 2 and 3, the fabric according to the invention may take several forms. As shown in FIG. 2, one fabric 10 according to the invention may take the form of a knitted fabric. The fabric shown in FIG. 2 is a weft knitted fabric of a plain jersey construction made entirely with the single electrically-conductive yarn 20. Preferably, a yarn made of nonconductive material (not shown) is knitted into the base fabric 10 to provide additional stability to the fabric and comfort to the wearer. For example, an acrylic yarn may be knitted on each course shown in FIG. 2 to form either the technical face or technical back as desired. The yarn of nonconductive material may be combined with the base fabric 10 using any of the commonly known textile methods (e.g., knitting, laying-in, etc.).

Alternatively, the base fabric could be formed of the yarn of nonconductive material. In this embodiment, the coiled electrically-conductive carbon fibers would be combined with the base fabric using any of the commonly known textile methods listed above.

As used herein the term nonconducting is defined as any material that is generally viewed by those skilled in the textile arts as nonconductive to electricity. For example, unmodified polyester (e.g., polyethylene terephthalate) is typically regarded as a nonconducting material for forming filaments, fibers and yarns. Unmodified nylon and acrylic yarns are also typically regarded as nonconducting. Accordingly, the yarn of nonconducting material may comprise fibers or filaments of polyester, nylon, or any other suitable nonconducting material or any combination of these. The fabric according to the invention may take the form of both circular and flat knitted fabrics.

Although FIG. 2 shows a weft knitted fabric, the invention is equally applicable to other fabric constructions such as warp knitted fabrics (e.g., Milanese knits, Raschel knits, and Tricot knits), single knitted fabrics, and double knitted fabrics, among others. An alternative exemplary fabric 10a is shown in FIG. 3. This fabric 10a is knitted in a rib construction to illustrate that the invention may utilize various fabric constructions.

An alternative embodiment of the fabric according to the invention includes fabrics possessing stripes formed from the single electrically-conductive yarn 20. For weft knit fabrics, the stripe could be as narrow as alternately knitting one course of a conductive yarn 20 with one course of a nonconductive yarn.

In a further alternative embodiment of the invention, the first electrically-conductive carbon fiber 25 and the second electrically-conductive carbon fiber 30 are coiled together by knitting a first electrically-conductive yarn 26 consisting essentially of the first electrically-conductive carbon fiber 25 with a second conductive yarn 28 consisting essentially of a second electrically-conductive carbon fiber 30. It should be understood that the second electrically-conductive carbon fiber 30 is not the same as the first electrically-conductive carbon fiber 25.

One possible representation of this embodiment is shown in FIG. 4. This fabric comprises a weft knit fabric characterized by alternating courses of a first conductive yarn 26 and a second conductive yarn 28. A nonconductive yarn may be knitted into this fabric as well.

A still further embodiment of the invention is a knitted fabric comprising a base fabric formed of nonconductive yarns having stripes of the two electrically-conductive yarns (26, 28) knitted therein. The stripe may be as thin as two warp ends knitted on adjacent wales. Preferably, this construction utilizes a base fabric knitted of nonconductive yarn having a first electrically-conductive yarn 26 knitted into and extending along a first and second wale and a second electrically-conductive yarn 28 knitted in opposition to the first selected yarn and extending along the same first and second selected wale. Stripes may also be formed by knitting the two electrically-conductive yarns (26, 28) in a crisscross pattern in a base fabric. Such a pattern is shown in FIG. 5.

The invention also encompasses fabric constructions in which the nonconductive yarn is knitted or woven into a base fabric and then the electrically-conductive yarns (26, 28) or the single electrically-conductive yarn 20 is processed into that fabric (e.g., the conductive yarns are laid-in). It should be understood that the invention also encompasses embodiments in which the base fabric is formed from the electrically-conductive fibers and the nonconductive yarn is processed into the electrically-conductive base fabric.

The fabric according to the invention need not be limited to just a single fabric that combines nonconductive yarns and conductive fibers. Also included within the scope of the invention are composite fabrics made from two or more individual fabrics. An example of such a composite fabric would be a composite fabric consisting of a first fabric knitted solely from a nonconductive yarn that is sewn or otherwise attached to a second fabric knitted solely from conductive fibers (e.g., the fabrics shown in FIGS. 2, 3, and 4).

### Examples of Preferred Fabric Constructions

In one particularly preferred embodiment, the fabric comprises a single electrically-conductive yarn 20 comprised of RESISTAT® and NEGASTAT® in any combination of available deniers. Commonly available deniers include 44, 55, and 84 denier RESISTAT® and 35, 70, and 140 denier NEGASTAT®. One preferred construction is a single knit, plain jersey made using 108 needles in a 3¾″ diameter cylinder, and a two-hole yarn finger. The primary yarn (face yarn) in the large hole of the finger is nylon but could also include polyester, acrylic, cotton or other nonconductive yarn or any combination thereof. The plaiting yarn (backing yarn) in the small hole of the finger is the single electrically-conductive yarn 20 and comprises 70 denier NEGASTAT® and 44 denier RESISTAT®. The single electrically-conductive yarn surfaces only on one side of the fabric and forms a vertical and horizontal contiguous matrix in the fabric.

Another preferred construction of weft knit design is a rib fabric produced on machines of various diameters and gauges with two sets of needle housing allowing the single electrically-conductive yarn 20 to form intermeshing stitches in opposite directions on a walewise basis. The single electrically-conductive yarn 20 surfaces on one side of the fabric in vertical ribs and forms a contiguous vertical and horizontal matrix in the fabric. The primary yarn in the large hole is a nonconductive yarn and may be varying sizes of nylon, polyester, acrylic, cotton or other nonconductive yarn. The plaiting yarn is a single electrically-conductive yarn 20 comprising 70 denier NEGASTAT® and 44 denier RESISTAT® that are twisted together.

Another preferred construction of weft knit design is a purl fabric. This fabric is similar to a rib fabric except that the intermeshing of loops in opposite directions occurs on a course-wise rather than a walewise basis.

As noted in the parent application, it is believed that the pain relieving aspects of the invention arise, at least in part, from the fabric's ability to induce an endogenous flow of current in the area of the body experiencing pain.

Without limiting the scope of the invention, it is theorized that the twisting of the two electrically-conductive carbon fibers 25 and 30 to form the single electrically-conductive yarn 20 and the looping created by the knitting of the first and second conductive yarns 26, 28 creates a number of electrical coils capable of generating electrical currents that flow on the surface of skin exposed to the fabric. It is believed that the electrical currents are generated as a result of interactions between the electrochemical reactions in the human body, the electrical charge in the atmosphere, and the electrical coils created by the looping or twisting of the conductive fibers or yarns as they make their various stitch configurations.

It should be understood, however, that the theories presented herein supporting pain relief are based upon data gathered to date and that research into the pain-relieving properties of this fabric continues. Therefore, the theories presented herein should not be interpreted as limiting the scope of the invention.

Subsequent testing data has strengthened this possible explanation of the pain relieving aspects of the invention. A conductive sock was tested to determine its electrical characteristics. The conductive sock was constructed as a plain jersey stitch of a single electrically-conductive yarn and a nonconducting acrylic yarn. The single electrically-conductive yarn consisted of 44 denier RESISTAT® twisted with 70 denier NEGASTAT®. The nonconductive yarn was 140 denier and formed the technical back of the fabric.

The results of the testing are shown in the following table.

Test Method: ESD STM 97.1

Test Equipment: Dr. Thiedig MegOhm Meter Applied voltage: 1 volt, 10 vdc

Electrodes: 2½ inch aluminum cylinder, Aluminum plate, Aluminum foil

Laboratory Conditions: 73° F., 12% relative humidity Resistance to Aluminum Plate at 10 Volts

| Bare Foot Only | Socked Foot | 5 lb. Electrode in Sock |
|---|---|---|
| 2.34 × 10⁴ Ω | 6.10 × 10⁶ Ω | 4.8 × 10⁵ Ω |

### Battery Action of Sock to Metal Plate (Voltage Generated by Sock)

| Socked Foot | 5 lb. Electrode in Sock |
|---|---|
| 600 mV | <1 mV |

In general, the above resistance test results show that a bare foot is much more conductive than a socked foot when placed in contact with a metal plate. This is expected because the conductivity of the foot is due to the sweat of the foot connecting the metal plate to the blood stream. The tests also show, however, that the resistance of the sock is only 480,000 Ohms. The resistance shown by a normal sock could be as much as 1000 times higher. Accordingly, the sock shows a resistance in the range that could be called conductive.

Furthermore, the battery action test results show that a socked foot in relatively dry humidity conditions generates a voltage of around 600 mV (0.6 V). It is believed that any construction of the inventive fabric will generate a voltage of at least 100 mV (0.1 V) and higher voltage generation is expected under more natural conditions when the foot experiences more perspiration.

Similar tests were conducted using warp knitted fabrics situated between a bare hand and an electrode. The warp knitted fabrics were shown to generate voltages between 400 mV and 550 mV.

The above test results indicate that the electrical currents established by the conductive fabric of the present invention cause concurrent waveforms to flow on the surface of exposed skin due to the battery action of the fabric.

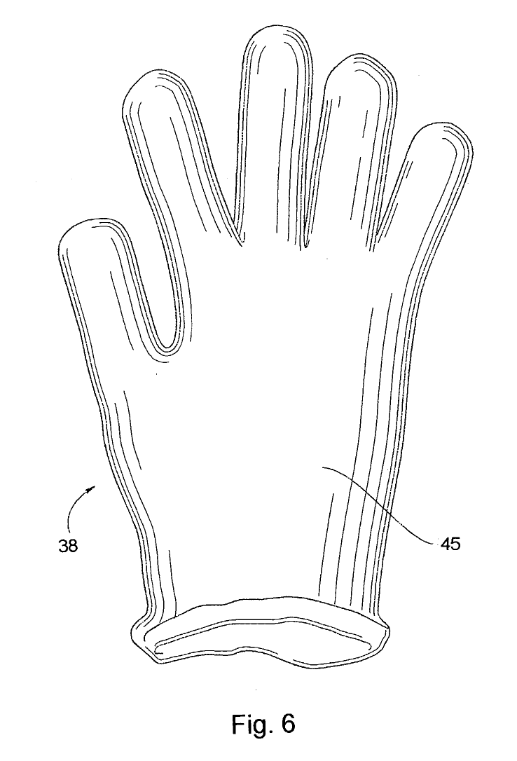

The fabric according to the invention is designed, in part, to be formed into garments that may be worn by a person or otherwise placed in contact with a person's skin. Any garment that can come into contact with skin is encompassed within the scope of this invention. A glove would be exemplary of such garments. A representative glove 38 incorporating a fabric according to the invention 45 is illustrated in FIG. 6.

Similarly, the fabric according to the invention is designed for use in textile articles such as garments, bandages, pads, appendage wraps, sheets, bedding pillows, shirts, pants, underwear, support garments, and other types of medical treatment devices such as braces. When used as a bandage or part of some other medical treatment device the invention should be interpreted to encompass other structures necessary to hold the fabric in place against the skin (e.g., straps, clips, adhesives, and the like) for the duration of desired pain relief.

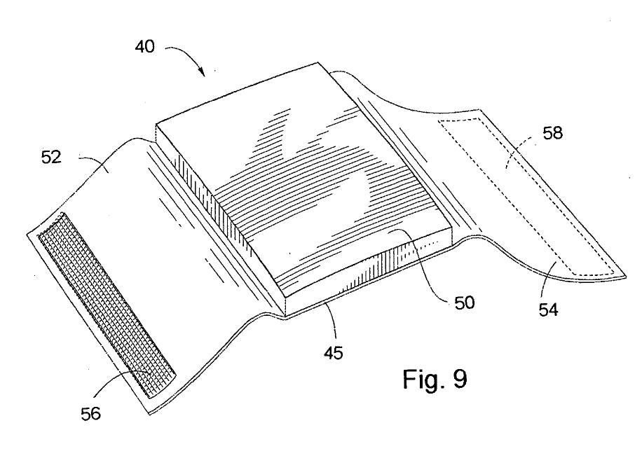

For example, as is shown in FIG. 9, a pad 40 of any suitable size and shape may be constructed for being applied to and held on the pain site. The pad 40 is constructed of a fabric 45 according to a preferred embodiment of the invention that is attached to a padding material 50. The fabric and pad may be attached by adhesive, sewing stitches, thermobonding, or other suitable attaching means. A pair of opposed straps 52 and 54 with complementary hood-and-loop fastener elements 56 and 58, respectively, permit the pad 40 to encircle a limb or other body area and remain in place as long as desired.

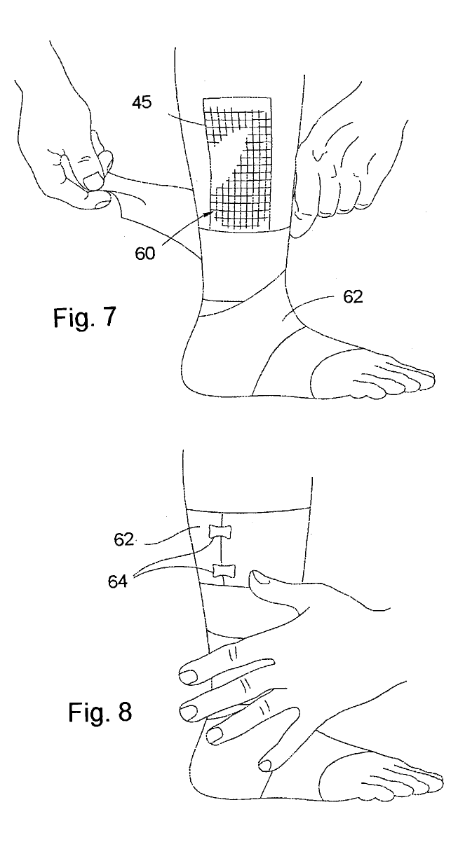

Referring to FIGS. 7 and 8, a bandage such as a splint 60 can be covered at least on the skin side of the splint 60 with a layer of fabric 45 in order to directly contact the skin. The fabric 45 is thereby held against the pain site along with the splint 60 by an overwrap of an elastic bandage 62 and retained in a suitably tensioned condition by clips 64, as shown in FIG. 8.

In another embodiment, the invention is a method of reducing endogenous pain by stimulating a flow of endogenous electrical current in the body. In broad terms, the method according to the invention comprises the steps of knitting a fabric comprising a yarn of nonconducting material and a first electrically-conductive carbon fiber coiled with a second electrically-conductive carbon fiber to create electrical contact between the two electrically-conductive carbon fibers. The fabric is then applied to a pain site and maintained in position on the pain site for the duration of desired relief.

In preferred embodiments the first electrically-conductive carbon fiber is chosen from the group consisting of carbon suffused nylon filamentary polymer substrates having finely divided, electrically-conductive particles embossed on the surface of the polymer; a core of electrically-conductive carbon surrounded by an electrically nonconductive polymer cover; and graphite fibers.

The second electrically-conductive carbon fiber is preferably chosen from the group consisting of carbon suffused nylon filamentary polymer substrates having finely divided, electrically-conductive particles embossed on the surface of the surface of the polymer; a core of electrically-conductive carbon surrounded by an electrically nonconductive polymer cover; and graphite fibers, but exclusive of the carbon fiber comprising the first electrically-conductive fiber.

In particularly preferred embodiments the first electrically-conductive carbon fiber comprises a carbon suffused nylon and the second electrically-conductive carbon fiber comprises a core of electrically-conductive carbon surrounded by an electrically nonconductive polymer cover.

The coiling of the first and second electrically-conductive fibers (25, 30) may be formed by twisting the first and second electrically-conductive fibers together to form a single electrically-conductive yarn 20. Alternatively, the first electrically-conductive carbon fiber and the second electrically-conductive carbon fibers (25, 30) are coiled together by knitting a first conductive yarn 26 consisting essentially of the first electrically-conductive fiber 25 with a second conductive yarn 28 consisting essentially of the second electrically-conductive fiber 30.

The step of knitting comprises any manner of knitting a fabric that comprises the above referenced nonconductive yarn and the electrically-conducting carbon fibers. Therefore, knitting includes knitting the single electrically-conductive yarn 20 with nonconductive yarns. Knitting also comprises forming a base fabric from the nonconductive yarn then knitting the first and second electrically-conductive fibers into the base nonconducting fabric either as individual conductive yarns (26, 28) or as a single twisted conductive yarn 20.

Similarly, the method of reducing endogenous pain may comprise knitting a first fabric consisting essentially of the yarn of nonconductive material and knitting a second fabric consisting essentially of the first and second electrically-conductive carbon fibers (or the single twisted conductive yarn 20) then joining the first and second fabrics.

The step of knitting the fabric may comprise knitting a base fabric consisting essentially of the first and second electrically-conductive carbon fibers (or the single twisted conductive yarn 20) then combining the yarn of nonconductive material with the base conductive fabric.

In most instances the step of applying the fabric to the pain site comprises placing the fabric in direct contact with skin for the period of desired pain relief. The fabric may also be separated from the pain site by a short distance; for example, the width of a pad.

The invention also encompasses a method of forming a knitted fabric for reducing endogenous pain by stimulating a flow of endogenous electrical current in the body. In broad terms the method comprises knitting a yarn of nonconductive material together with a first electrically-conductive carbon fiber 25 and a second electrically-conductive carbon fiber 30 wherein the first and second electrically-conductive carbon fibers (25, 30) are coiled to create electrical contact between the first and second electrically-conductive carbon fibers (25, 30).

Preferably, the first electrically-conductive carbon fiber 25 is chosen from the group consisting of carbon suffused nylon filamentary polymer substrates having finely divided, electrically-conductive particles embossed on the surface of the polymer; a core of electrically-conductive carbon surrounded by an electrically nonconductive polymer cover; and graphite fibers.

The second electrically-conductive carbon fiber 30 is chosen from the group consisting of carbon suffused nylon filamentary polymer substrates having finely divided, electrically-conductive particles embossed on the surface of the surface of the polymer; a core of electrically-conductive carbon surrounded by an electrically nonconductive polymer cover; and graphite fibers, but exclusive of the carbon fiber comprising the first electrically-conductive fiber.

In preferred embodiments of this method the first electrically-conductive carbon fiber 25 comprises a carbon suffused nylon and the second electrically-conductive carbon fiber 30 comprises a core of electrically-conductive carbon surrounded by an electrically nonconductive polymer cover. The commercially available RESISTAT® and NEGASTAT® fibers discussed earlier are examples of such fibers.

The coiling of first and second electrically-conductive carbon fibers (25, 30) may be accomplished by twisting the first and second electrically-conductive carbon fibers (25, 30) into a single electrically-conductive yarn 20. Alternatively, the first electrically-conductive carbon fiber 25 and the second electrically-conductive carbon fiber 30 are coiled together by knitting a first conductive yarn 26 consisting essentially of the first electrically-conductive fiber 25 with a second conductive yarn 28 consisting essentially of the second electrically-conductive fiber 30.

As noted above, the method of forming a knitted fabric for reducing endogenous pain by stimulating a flow of endogenous electrical current in the body comprises a knitting step. The knitting steps utilized in the method of forming the fabric are identical to the knitting steps discussed above in relation to the method of treating endogenous pain and the knitting discussion related to the fabric according to the invention.

The methods according to the invention further comprise forming a textile article from the fabric. Textile articles within the scope of the invention include garments, bandages, pads, appendage wraps, gloves, braces, socks, sheets, bedding, pillows, shirts, pants, underwear, and support garments.

That which is claimed is:

1. A fabric for reducing endogenous pain by application of the fabric to a pain site to facilitate the flow of endogenous electrical current in the body, and comprising:
a yarn of nonconducting material; and
a first electrically-conductive carbon fiber coiled with a second electrically-conductive carbon fiber to create electrical contact between the two electrically-conductive carbon fibers.

2. A fabric according to claim 1,
wherein the first electrically-conductive carbon fiber is chosen from the group consisting of carbon suffused nylon filamentary polymer substrates having finely divided, electrically-conductive particles embossed on the surface of the polymer; a core of electrically-conductive carbon surrounded by an electrically nonconductive polymer cover; and graphite fibers, and
wherein the second electrically-conductive carbon fiber is chosen from the group consisting of carbon suffused nylon filamentary polymer substrates having finely divided, electrically-conductive particles embossed on the surface of the surface of the polymer; a core of electrically-conductive carbon surrounded by an electrically nonconductive polymer cover; and graphite fibers, but exclusive of the carbon fiber comprising the first electrically-conductive fiber.

3. A fabric according to claim 2, wherein the first electrically-conductive carbon fiber comprises a carbon suffused nylon and the second electrically-conductive carbon fiber comprises a core of electrically-conductive carbon surrounded by an electrically nonconductive polymer cover.

4. A fabric according to claim 1 wherein said first electrically-conductive carbon fiber and said second electrically conductive carbon fiber are coiled together by twisting said fibers into a single electrically-conductive yarn.

5. A fabric according to claim 4 wherein said single electrically-conductive yarn is between about 1 denier and about 180 deniers.

6. A fabric according to claim 4 wherein said single electrically-conductive yarn is knitted into a fabric.

7. A fabric according to claim 1 wherein said first electrically-conductive carbon fiber and said second electrically-conductive carbon fiber are coiled together by knitting a first conductive yarn consisting essentially of said first electrically-conductive fiber with a second conductive yarn consisting essentially of said second electrically-conductive fiber.

8. A fabric according to claim 7 wherein said first conductive yarn and said second conductive yarn are knitted together in alternating courses.

9. A fabric according to claim 7 wherein said fabric comprises a knitted base fabric in which said first and second conductive yarns are knitted in a crisscross pattern to form at least one stripe in said base fabric.

10. A fabric according to claim 9 wherein said fabric comprises a knitted base fabric having said first conductive yarn knitted into and extending along a first and second selected wale and said second conductive yarn knitted in opposition to the first conductive yarn and extending along the same first and second selected wale.

11. A fabric according to claim 1 wherein said fabric comprises
a first fabric consisting essentially of said yarn of nonconducting material; and
a second fabric consisting essentially of said coiled first and second electrically-conductive fibers.

12. A fabric according to claim 1 wherein said fabric generates an electrical current across the surface of skin when said fabric is placed in contact with skin.

13. A fabric according to claim 1 wherein said fabric generates a voltage of at least 0.1 Volts when placed in contact with human skin and an aluminum plate.

14. A textile article constructed from a fabric according to claim 1.

15. A textile article according to claim 14 wherein said article is selected from the group consisting of garments, bandages, pads, appendage wraps, gloves, braces, socks, sheets, bedding, pillows, shirts, pants, underwear, and support garments.

16. A method of reducing endogenous pain by stimulating a flow of endogenous electrical current in the body, the method comprising the steps of:
(a) knitting a fabric comprising:
(i) a yarn of nonconducting material; and
(ii) a first electrically-conductive carbon fiber coiled with a second electrically-conductive carbon fiber to create electrical contact between the two electrically-conductive carbon fibers;
(b) applying the fabric to a pain site; and
(c) maintaining the fabric on the pain site for the duration of desired relief.

17. A method according to claim 16
wherein the first electrically-conductive carbon fiber is chosen from the group consisting of carbon suffused nylon filamentary polymer substrates having finely divided, electrically-conductive particles embossed on the surface of the polymer; a core of electrically-conductive carbon surrounded by an electrically nonconductive polymer cover; and graphite fibers, and
wherein the second electrically-conductive carbon fiber is chosen from the group consisting of carbon suffused nylon filamentary polymer substrates having finely divided, electrically-conductive particles embossed on the surface of the surface of the polymer; a core of electrically-conductive carbon surrounded by an electrically nonconductive polymer cover; and graphite fibers, but exclusive of the carbon fiber comprising the first electrically-conductive fiber.

18. A method according to claim 17 wherein the first electrically-conductive carbon fiber comprises a carbon suffused nylon and the second electrically-conductive carbon fiber comprises a core of electrically-conductive carbon surrounded by an electrically nonconductive polymer cover.

19. A method according to claim 16 wherein the coiling of the first and second electrically-conductive fibers is formed by twisting the first and second electrically-conductive fibers together to form a single electrically-conductive yarn.

20. A method according to claim 19 wherein the step of knitting comprises knitting the single electrically-conductive yarn with the nonconductive yarn.

21. A method according to claim 16 wherein the first electrically-conductive carbon fiber and the second electrically-conductive carbon fiber are coiled together by knitting a first conductive yarn consisting essentially of said first electrically-conductive fiber with a second conductive yarn consisting essentially of said second electrically-conductive fiber.

22. A method according to claim 21 wherein the step of knitting the fabric comprises forming a base fabric from the yarn of nonconducting material then knitting the first and second electrically-conductive fibers into the base fabric.

23. A method according to claim 16 wherein the step of knitting the fabric comprises knitting a first fabric consisting essentially of the yarn of nonconductive material and knitting a second fabric consisting essentially of the first and second electrically-conductive carbon fibers then joining the first and second fabrics.

24. A method according to claim 16 wherein the step of knitting the fabric comprises knitting a base fabric consisting essentially of the first and second electrically-conductive carbon fibers then combining the yarn of nonconductive material with the base fabric.

25. A method according to claim 16 wherein the step of applying the fabric to the pain site comprises placing the fabric in direct contact with skin.

26. A method of forming a knitted fabric for reducing endogenous pain by stimulating a flow of endogenous electrical current in the body, the method comprising:
knitting a yarn of nonconductive material together with a first electrically-conductive carbon fiber and a second electrically-conductive carbon fiber,
wherein said first and second electrically-conductive carbon fibers are coiled to create electrical contact between the first and second electrically-conductive carbon fibers.

27. A method according to claim 26 wherein the first electrically-conductive carbon fiber is chosen from the group consisting of carbon suffused nylon filamentary polymer substrates having finely divided, electrically-conductive particles embossed on the surface of the polymer; a core of electrically-conductive carbon surrounded by an electrically nonconductive polymer cover; and graphite fibers, and
wherein the second electrically-conductive carbon fiber is chosen from the group consisting of carbon suffused nylon filamentary polymer substrates having finely divided, electrically-conductive particles embossed on the surface of the surface of the polymer; a core of electrically-conductive carbon surrounded by an electrically nonconductive polymer cover; and graphite fibers, but exclusive of the carbon fiber comprising the first electrically-conductive fiber.

28. A method according to claim 27 wherein the first electrically-conductive carbon fiber comprises a carbon suffused nylon and the second electrically-conductive carbon fiber comprises a core of electrically-conductive carbon surrounded by an electrically nonconductive polymer cover.

29. A method according to claim 26 wherein the coiling of first and second electrically-conductive carbon fibers is formed by twisting the first and second electrically-conductive carbon fibers into a single electrically-conductive yarn.

30. A method according to claim 29 further comprising knitting the yarn of nonconductive material together with the single electrically-conductive yarn.

31. A method according to claim 29 wherein the step of knitting comprises knitting a base fabric comprising the yarn of nonconductive material then combining the base fabric and the single electrically-conductive yarn.

32. A method according to claim 26 wherein the step of knitting comprises knitting a base fabric consisting essentially of the first and second electrically conductive carbon fibers then combining the yarn of nonconductive material with the base fabric.

33. A method according to claim 26 wherein the coil of first and second electrically-conductive carbon fibers is formed by knitting a first conductive yarn consisting essentially of the first electrically-conductive fiber with a second conductive yarn consisting essentially of the second electrically-conductive fiber.

34. A method according to claim 33 wherein the first conductive yarn and the second conductive yarn are knitted together in alternating courses.

35. A method according to claim 33 wherein the fabric comprises a knitted base fabric having said first conductive yarn knitted into and extending along a first and second selected wale and said second conductive yarn knitted in opposition to the first conductive yarn and extending along the same first and second selected wale.

36. A method according to claim 33 wherein the step of knitting comprises knitting a base fabric from the yarn of nonconductive material then knitting the first and second conductive yarns in a crisscross pattern in the base fabric.

37. A method according to claim 26 further comprising forming a textile article from the fabric.

38. A method according to claim 37 wherein said textile article is selected from the group consisting of garments, bandages, pads, appendage wraps, gloves, braces, socks, sheets, bedding, pillows, shirts, pants, underwear, and support garments.
